(19) United States
(12) Patent Application Publication
(10) Pub. No.: US 2026/0312071 A1
(43) Pub. Date: Oct. 8, 2026

(54) ELECTRODE CURRENT COLLECTORS, ELECTRODES, AND RECHARGEABLE LITHIUM BATTERIES

(71) Applicant: SAMSUNG SDI CO., LTD., Yongin-si (KR)

(72) Inventor: Yohan JEONG, Yongin-si (KR)

(73) Assignee: SAMSUNG SDI CO., LTD., Yongin-si (KR)

(21) Appl. No.: 19/557,349

(22) Filed: Mar. 5, 2026

(30) Foreign Application Priority Data
Apr. 2, 2025 (KR) 10-2025-0042989

(51) Int. Cl. H01M 4/66; H01M 10/052

(52) U.S. Cl. CPC H01M 4/667; H01M 4/661; H01M 4/668; H01M 10/052

(57) ABSTRACT

Disclosed are an electrode current collector, an electrode, and a rechargeable lithium battery. The electrode current collector includes a first metal layer, a second metal layer, and a polymer layer between the first metal layer and the second metal layer. The polymer layer includes a first polymer and a second polymer, the first polymer includes at least one of polyurethane, polyethylene, polycarbonate, polydimethylsiloxane, or a combination thereof, and the second polymer includes at least one of polycaprolactone, polylactide, polyglycolic acid, or a combination thereof.

### CROSS-REFERENCE TO RELATED APPLICATION

This application claims priority to Korean Patent Application No. 10-2025-0042989 filed with the Korean Intellectual Property Office on Apr. 2, 2025, the entire contents of which are incorporated herein by reference.

### BACKGROUND

### 1. Field

Electrode current collectors, electrodes, and rechargeable lithium batteries are disclosed.

### 2. Description of the Related Art

A portable information device such as, e.g., a cell phone, a laptop, smart phone, and the like, or an electric vehicle, typically uses a rechargeable lithium battery having high energy density and easy portability as a driving power source. For example, using a rechargeable lithium battery with high energy density as a driving power source or power storage power source for hybrid or electric vehicles may be advantageous.

Rechargeable lithium batteries include a positive electrode and a negative electrode including an active material capable of intercalating and deintercalating lithium ions, and an electrolyte solution, and electrical energy is produced through oxidation and reduction reactions when lithium ions are intercalated/deintercalated from the positive electrode and negative electrode.

Transition metal compounds such as lithium cobalt-based oxide, lithium nickel-based oxide, and lithium manganese-based oxide may be used as positive electrode active materials for rechargeable lithium batteries, and crystalline carbon materials such as natural graphite or artificial graphite or amorphous carbon materials may be used as negative electrode active materials.

### SUMMARY

Some example embodiments include an electrode current collector, an electrode, and a rechargeable lithium battery that can improve safety by reducing or suppressing deformation and improve the cycle-life of the battery.

Some example embodiments include an electrode current collector including a first metal layer, a second metal layer, and a polymer layer between the first metal layer and the second metal layer. The polymer layer includes a first polymer and a second polymer, the first polymer includes at least one of polyurethane, polyethylene, polycarbonate, polydimethylsiloxane, or a combination thereof, and the second polymer includes at least one of polycaprolactone, polylactide, polyglycolic acid, or a combination thereof.

Some example embodiments include an electrode including the aforementioned electrode current collector.

Some example embodiments include a rechargeable lithium battery including a positive electrode, a negative electrode, and an electrolyte. At least one of the positive electrode and the negative electrode is the aforementioned electrode.

According to some example embodiments, provided are an electrode collector, an electrode, and a rechargeable lithium battery that can improve safety by reducing or suppressing deformation and improve the cycle-life of the battery.

### BRIEF DESCRIPTION OF THE DRAWINGS

FIG. 1 to FIG. 4 are views schematically showing rechargeable lithium batteries according to some example embodiments.

FIG. 5 is a CT image of a cross-section of a jelly-roll in a cylindrical battery manufactured using the same method as the battery cell manufactured in Example 1.

FIG. 6 is a CT image of a cross-section of a jelly-roll in the cylindrical battery manufactured using the same method as the battery cell manufactured in Comparative Example 1.

### DETAILED DESCRIPTION

Hereinafter, example embodiments are described in detail so that those of ordinary skill in the art can readily implement the example embodiments. However, this disclosure may be embodied in many different forms and is not construed as limited to the example embodiments set forth herein.

The terminology used herein is used to describe example embodiments only, and is not intended to limit the present disclosure. The singular expression includes the plural expression unless the context clearly dictates otherwise.

As used herein, “combination thereof” means a mixture, a laminate, a composite, a copolymer, an alloy, a blend, a reaction product, and the like of the constituents.

Here, it should be understood that terms such as “comprises,” “includes,” or “have” are intended to designate the presence of an embodied feature, number, step, element, or a combination thereof, but do not preclude the possibility of the presence or addition of one or more other features, number, step, element, or a combination thereof.

In the drawings, the thickness of layers, films, panels, regions, and the like, may be exaggerated for clarity, and like reference numerals designate like elements throughout the specification. It is understood that when an element such as a layer, film, region, or substrate is referred to as being “on” another element, the element can be directly on the other element, or intervening elements may also be present therebetween. In contrast, when an element is referred to as being “directly on” another element, there may not be intervening elements present.

In addition, “layer” herein includes not only a shape formed on the whole surface when viewed from a plan view, but also a shape formed on a partial surface.

The average particle diameter may be measured by a method known to those skilled in the art, for example, by a particle size analyzer, or by a transmission electron microscope image or a scanning electron microscope image. Alternatively, it is possible to obtain an average particle diameter value by measuring using a dynamic light scattering method, performing data analysis, counting the number of particles for each particle size range, and calculating from this. Unless otherwise defined, the average particle diameter may mean the diameter (D₅₀) of particles having a cumulative volume of 50 volume % in the particle size distribution. As used herein, when a definition is not otherwise provided, the average particle diameter means a diameter (D₅₀) of particles having a cumulative volume of 50 volume % in the particle size distribution that is obtained by measuring the size (diameter or major axis length) of about 20 particles at random in a scanning electron microscope image.

Here, “or” is not to be construed as an exclusive meaning, for example, “A or B” is construed to include A, B, A+B, and the like.

“Metal” is interpreted as a concept including ordinary metals, transition metals and metalloids (semi-metals).

“Thickness” may be measured, for example, from photographs taken with an optical microscope such as, e.g., a scanning electron microscope.

When the terms “about” or “substantially” are used in this specification in connection with a numerical value, it is intended that the associated numerical value include a tolerance of ±10% around the stated numerical value. When ranges are specified, the range includes all values therebetween such as increments of 0.1%.

### Electrode Current Collector

Some example embodiments include an electrode current collector including a first metal layer, a second metal layer, and a polymer layer between the first metal layer and the second metal layer. The polymer layer includes a first polymer and a second polymer. The first polymer includes at least one of polyurethane, polyethylene, polycarbonate, polydimethylsiloxane, or a combination thereof, and the second polymer includes at least one of polycaprolactone, polylactide, polyglycolic acid, or a combination thereof.

A rechargeable lithium battery may experience volume changes along with intercalation and deintercalation of lithium ions during the charge and discharge. For example, a silicon-based material used to increase capacity of a negative electrode undergoes volume expansion during the charge and discharge. Because the inside of the battery is made up of a limited space, if (when) stress caused by the volume changes of an electrode plate is not effectively released, there may be a challenge such as, e.g., deformation of an electrode.

These electrode expansion and stress relief processes may readily lead to structural deformation in a cylindrical battery having a jelly-roll structure, which is pointed out as one of the typical chronic defects. For example, the deformation tends to be concentrated towards a winding core direction of the jelly-roll structure where there is an internal empty space of the battery, and thus may cause damage on the battery or an internal short circuit of the battery, thereby seriously affecting battery stability.

Conventionally, there have been various attempts to reduce or suppress the battery deformation, such as structural reinforcement or material improvement, which effectiveness may be limited. For example, in application fields requiring long-term use in high-temperature environments, such as solar power generation and storage systems, military applications, and GPS tracking systems, the battery stability may be critically limited due to the insufficient function of reducing or suppressing the deformation.

Accordingly, some example embodiments address the aforementioned challenge by introducing a shape memory polymer material recovering the original shape thereof at a desired or predetermined temperature into an electrode current collector. Through this, as the structural deformation occurring during the charge and discharge process of a rechargeable lithium battery such as a cylindrical battery may be effectively reduced or suppressed, the electrode current collector, which may improve battery safety and increase battery cycle-life even in high-temperature environments, is provided.

The electrode current collector according to some example embodiments includes a first metal layer, a second metal layer, and a polymer layer between the first metal layer and the second metal layer. In this way, by introducing a polymer layer including a shape memory polymer material as an electrode current collector between two metal layers to form a triple-layer structure, deformation may be reduced or suppressed due to the property of the shape memory polymer to recover the original shape thereof at a specific temperature, thereby reducing or suppressing damage and short-circuiting of the battery and ensuring desired or improved safety.

The polymer layer includes a first polymer and a second polymer, wherein the first polymer includes at least one of polyurethane, polyethylene, polycarbonate, polydimethylsiloxane, or a combination thereof, and the second polymer includes at least one of polycaprolactone, polylactide, polyglycolic acid, or a combination thereof. Because the polymer layer includes the aforementioned first polymer and second polymer, the polymer layer may constitute a shape memory polymer by exhibiting a property of recovering its original shape at a desired or predetermined temperature, and by using this, deformation may be reduced or suppressed, and the safety of the battery may be increased.

The shape memory polymer (SMP) refers to a polymer that has the property of recovering the original shape thereof at a desired or predetermined temperature. The operating principle of this shape memory polymer is as follows. First, the polymer is heated above the transformation temperature thereof, such as the glass transition temperature (Tg) or melting temperature (Tm), to make it easy to deform, and then an external force is applied to deform the polymer into the desired shape (shape fixation). Then, when the polymer is cooled below the transformation temperature in the deformed state and the external force is removed, an arbitrary shape is fixed (shape memory). Afterwards, when heated again above the transformation temperature, the polymer has the property of returning to the original remembered shape thereof (shape recovery). By these shape fixation and shape memory processes, the shape may be recovered only when heated, and shape recovery may not occur when cooling. In order to constitute such a shape memory polymer, the polymer layer of the electrode current collector according to some example embodiments includes the first polymer and the second polymer described above, through which the polymer layer has a property of recovering the shape thereof, thereby enabling control of the shape according to changes in external conditions, and thereby can be utilized to reduce or suppress deformation of the battery by controlling external temperature conditions.

In the polymer layer, in order for the polymer including the first polymer and the second polymer to constitute the aforementioned shape memory polymer, the polymer should include a combination of a soft segment for absorbing external stress applied to the polymer layer and a hard segment that constitutes an operating point for shape recovery.

Therefore, in the polymer layer, the first polymer including at least one of polyurethane, polyethylene, polycarbonate, polydimethylsiloxane, or a combination thereof may constitute a soft segment that absorbs external stress and provides flexibility during deformation and recovery processes. That is, the first polymer may constitute a flexible and elastic portion in the polymer layer, and is mainly composed of or including amorphous polymer chains, and can play a role in absorbing deformation and stress.

Meanwhile, in the polymer layer, the second polymer including at least one of polycaprolactone, polylactide, polyglycolic acid, or the combination thereof may form a hard and highly crystalline portion in the polymer layer, thereby not only providing mechanical strength, but also acting as an operating point of a shape recovery as a shape memory polymer, so that the polymer can spontaneously restore the original shape thereof from a deformed state when a desired or predetermined temperature is reached.

For example, the transformation temperature of the polymer including the first polymer and the second polymer (or the transformation temperature of the polymer layer) may be greater than or equal to about 60° C., about 60° C. to about 150° C., about 70° C. to about 150° C., or about 80° C. to about 120 about ° C. When the above is satisfied, the electrode current collector may exhibit a characteristic of recovering the shape thereof when exposed to a high-temperature environment such as the above-mentioned transformation temperature, and as a result, deformation may be reduced or suppressed as the deformation force of the electrode current collector is offset by the recovery force of the polymer. By utilizing these characteristics, the electrode current collector can be effectively applied to batteries in fields such as solar power generation and storage systems used in high-temperature environments, military purposes, and GPS tracking systems. The deformation force of the battery and the recovery force of the shape memory polymer are offset to reduce or suppress the occurrence of deformation, thereby further improving stability and enabling the use of long cycle-life batteries.

For example, when the electrode current collector is used to manufacture a cylindrical battery, the cylindrical battery may maintain a spirally-rolled shape at about 25° C., but exhibit a property of trying to recover to the original flat and spread-out shape thereof at higher temperatures than the deformation temperature, such as about 60° C. or higher. This property of flattening out in the high-temperature environments may have an effect of compensating the deformation that occurs during the long-term charge/discharge cycles of the batteries or weakening the deformation force to suppress or delay the deformation.

For example, the polymer layer may include the first polymer in an amount in a range of about 50 wt % to about 90 wt %, about 60 wt % to about 90 wt %, or about 70 wt % to about 90 wt % based on the total 100 wt % of the first polymer and the second polymer. Within the ranges, while maintaining the effect of securing shape resilience within the polymer layer by adding the second polymer, a soft segment that reversibly acts within the polymer layer may be sufficiently secured, effectively providing flexibility during the deformation and recovery processes.

For example, the polymer layer may include the second polymer in an amount in a range of about 10 wt % to about 50 wt %, about 10 wt % to about 40 wt %, or about 10 wt % to about 30 wt % based on the total 100 wt % of the first polymer and the second polymer. Within the above ranges, while maintaining the effect of absorbing the deformation and stress and providing the flexibility within the polymer layer by adding the first polymer, a hard segment that constitutes a fixed phase within the polymer layer may be sufficiently secured, thereby improving the shape resilience.

For example, a thickness of the polymer layer may be in a range of about 1 μm to about 10 μm, about 2 μm to about 10 μm, about 2 μm to about 8 μm, or about 3 μm to about 7 μm. Within the above ranges, while sufficiently securing the shape resilience in the high-temperature environments by the polymer layer, the polymer layer may secure a sufficient thickness to effectively disperse the stress, and also increase resistance to the deformation, thereby contributing to improving durability and long-term stability of the battery and thus enhancing performance of the battery.

For example, the polymer layer may further include a conductive material, through which electrical conductivity of the polymer layer may be increased to lower electrical conductivity of the polymer layer that constitutes a shape memory polymer but promote a current flow, thereby improving output performance of the battery.

For example, the conductive material is included to provide polymer layer with the conductivity, and any electrically conductive material may be used as a conductive material unless the electrically conductive material causes an adverse chemical change in a battery to be constructed. Examples of the conductive material may include a carbon-based material such as at least one of natural graphite, artificial graphite, carbon black, acetylene black, Ketjen black, a carbon fiber, a carbon nanofiber, a carbon nanotube, and the like; a metal-based material of a metal powder or a metal fiber including at least one of copper, nickel, aluminum, silver, and the like; a conductive polymer such as a polyphenylene derivative; or a mixture thereof.

For example, in the polymer layer, the conductive material may be included in an amount greater than 0 wt % and less than or equal to about 10 wt %, in a range of about 0.01 wt % to about 8 wt %, about 0.03 wt % to about 6 wt %, or about 0.05 wt % to about 5 wt % based on 100 wt % of the polymer layer. Within the above ranges, the electrical conductivity of the polymer layer may be improved to lower electrical resistance, thereby improving output performance of the battery and maintaining shape recovery performance without deterioration.

For example, the polymer layer may include a total of the first polymer and the second polymer within a range of greater than or equal to about 90 wt % and less than about 100 wt %, about 92 wt % to about 99.99 wt %, about 94 wt % to about 99.97 wt %, or about 95 wt % to about 99.95 wt % based on 100 wt % of the polymer layer. Within the above ranges, the polymer layer may improve or maximize the effect of reducing or suppressing the deformation of the battery but improving safety and performance of the battery in high-temperature environments.

For example, the first metal layer and the second metal layer may each independently include at least one of indium (In), copper (Cu), magnesium (Mg), stainless steel (SUS), titanium (Ti), iron (Fe), cobalt (Co), nickel (Ni), zinc (Zn), aluminum (Al), germanium (Ge), lithium (Li), or a combination thereof. By satisfying the above, the structural stability of the battery may be secured and the resistance to expansion and contraction stress that occurs during repeated charging and discharging of the battery may be increased.

For example, if (when) the electrode of the electrode current collector is a positive electrode, the electrode current collector may be or include a positive electrode current collector, and if (when) the electrode of the electrode current collector is a negative electrode, the electrode current collector may be or include a negative electrode current collector. Accordingly, the following explanation may be equally applied to the contents of both the positive and negative electrodes.

For example, when the electrode of the electrode current collector is a positive electrode, the electrode current collector (i.e., the positive electrode current collector) may include at least one of aluminum (Al), stainless steel (SUS), or a combination thereof, but is not limited thereto. In addition, when the electrode of the electrode current collector is a negative electrode, the electrode current collector (i.e., the negative electrode current collector) may include at least one of indium (In), copper (Cu), magnesium (Mg), stainless steel (SUS), titanium (Ti), iron (Fe), cobalt (Co), nickel (Ni), zinc (Zn), aluminum (Al), germanium (Ge), lithium (Li), or a combination thereof, but is not limited thereto. As a representative example, the electrode of the electrode current collector may be or include a positive electrode, and the electrode current collector (i.e., positive electrode current collector) may be or include aluminum (Al). Alternatively, the electrode of the above electrode current collector may be or include a negative electrode, and the electrode current collector (i.e., the negative electrode current collector) may be or include copper (Cu).

For example, a thickness of the first metal layer may be in a range of about 1 μm to about 20 μm, about 2 μm to about 15 μm, about 3 μm to about 10 μm, or about 4 μm to about 8 μm, and/or a thickness of the second metal layer may be about 1 μm to about 20 μm, about 2 μm to about 15 μm, about 23 μm to about 10 μm, or about 4 μm to about 8 μm. Within the above range, the flexibility of the electrode current collector may be secured so that the deformation recovery characteristics by the polymer layer may be smoothly exhibited, while the desired mechanical strength and conductivity of the electrode current collector can be secured so that the structural stability and durability of the electrode current collector may be secured.

For example, a thickness ratio of the first metal layer and the second metal layer may be in a range of about 3:7 to about 7:3, about 4:6 to about 6:4, or about 4:6 to about 5:5, and for example, the thicknesses of the first metal layer and the second metal layer may be the same. Within the above range, flexibility and mechanical strength by the first metal layer and the second metal layer may be balanced, and the thickness of each of the first metal layer and the second metal layer may be adjusted to desired ranges to achieve a substantially uniform distribution, thereby providing equal resistance to external stress. This minimizes the stress concentrated in a specific direction, thereby minimizing the interference factors in the recovery process of deformation by the polymer layer and improving or maximizing the recovery ability to the original state.

For example, a total thickness of the first metal layer and the second metal layer may be in a range of about 50 thickness % to about 95 thickness %, about 60 thickness % to about 90 thickness %, or about 70 thickness % to about 85 thickness % based on a total thickness, 100 thickness % of the electrode current collector. Within the above range, the electrode current collector may sufficiently secure mechanical strength and durability to increase the ability to resist stress caused by expansion and contraction of the electrode during the charge and discharge process, which may contribute to reducing or preventing deformation of the electrode current collector. In addition, by ensuring sufficient electrical conductivity, the flow of current may be smoothed, thereby improving energy efficiency, and the first metal layer and the second metal layer may constitute a substantially uniform support for the polymer layer located in the middle, thereby ensuring both shape recovery of the polymer layer and stability of the entire electrode current collector. Ultimately, the mechanical strength, electrical conductivity, and resilience of the polymer layer may be maintained in a balanced manner, thereby simultaneously or contemporaneously improving the stability and performance of the battery.

For example, the total thickness of the first metal layer and the second metal layer may be greater than the thickness of the polymer layer, the thickness of the first metal layer may be greater than the thickness of the polymer layer, and/or the thickness of the second metal layer may be greater than the thickness of the polymer layer. If (when) the above conditions are satisfied, the effects of securing structural stability and durability of the electrode current collector by the first metal layer and the second metal layer, and the effects of securing shape resilience by the polymer layer, may be harmoniously achieved.

For example, the thickness of the polymer layer may be in a range of about 5 thickness % to about 50 thickness %, about 10 thickness % to about 40 thickness %, or about 15 thickness % to about 30 thickness % based on the total thickness, 100 thickness % of the electrode current collector (i.e., the total thickness of the first metal layer, the second metal layer, and the polymer layer). Within the above range, it is possible to sufficiently secure shape recovery in a high-temperature environment by the polymer layer, while also securing a sufficient polymer layer thickness to effectively disperse stress, and also to increase resistance to deformation, thereby contributing to improving the durability and long-term stability of the battery and improving the performance of the battery.

For example, the thickness of the polymer layer may be in a range of about 3 thickness % to about 50 thickness %, about 5 thickness % to about 48 thickness %, or about 15 thickness % to about 45 thickness % based on the total thickness, 100 thickness % of the first metal layer and the second metal layer. Within the above range, the effects of securing structural stability and durability of the electrode current collector by the first metal layer and the second metal layer, and the effects of securing shape resilience by the polymer layer, may be harmoniously achieved.

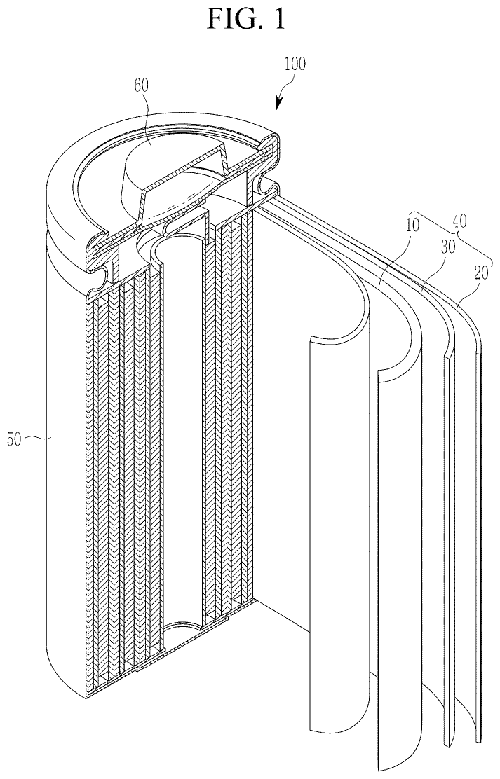

In some example embodiments, the electrode current collector may be used in a cylindrical battery form, and the electrode current collector may be wound into a jelly-roll shape and inserted into a cylindrical battery as illustrated in FIG. 1, and the cells may be assembled to form a battery.

### Electrode

Some example embodiments include an electrode including the aforementioned electrode current collector. The electrode may be at least one of a positive electrode and a negative electrode, and the description given below may be equally applied to the positive electrode and negative electrode.

For example, the electrode may be a positive electrode, and the first metal layer and the second metal layer may include aluminum.

For example, the electrode may be a negative electrode, and the first metal layer and the second metal layer may include copper.

### Rechargeable Lithium Battery

Some example embodiments include a rechargeable lithium battery including a positive electrode, a negative electrode, and an electrolyte. At least one of the positive electrode and the negative electrode is the aforementioned electrode.

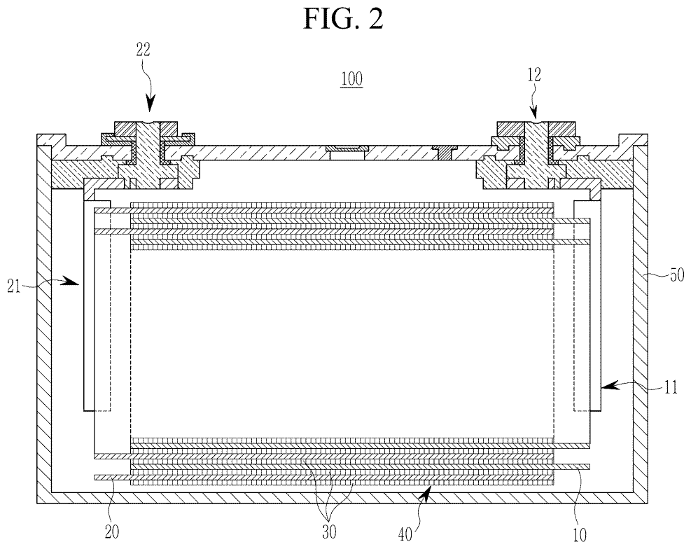

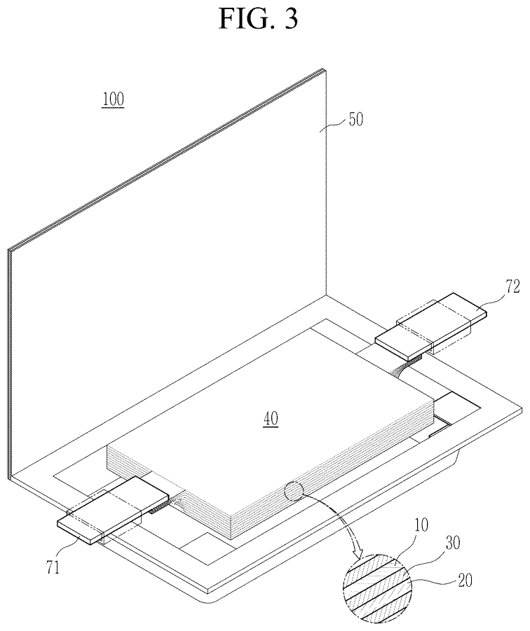

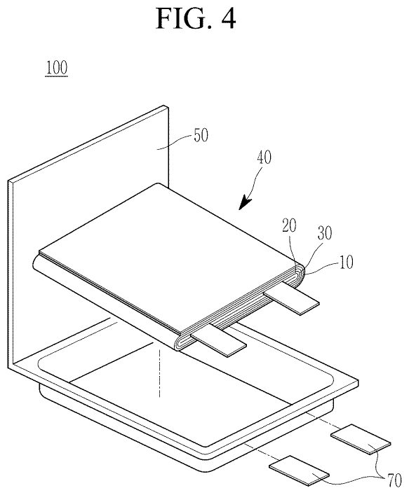

The rechargeable lithium battery may be classified into cylindrical, prismatic, pouch, coin, and the like, depending on the shape thereof. FIG. 1 to FIG. 4 are schematic views showing the rechargeable lithium battery according to some example embodiments, where FIG. 1 is a cylindrical battery, FIG. 2 is a prismatic battery, and FIG. 3 and FIG. 4 are a pouch-shaped battery. Referring to FIG. 1 to FIG. 4, a rechargeable lithium battery 100 includes an electrode assembly 40 with a separator interposed between the positive electrode 10 and the negative electrode 20, and a case 50 in which the electrode assembly 40 is housed. The positive electrode 10, the negative electrode 20, and the separator 30 may be impregnated with an electrolyte solution (not shown). The rechargeable lithium battery 100 may include a sealing member 60 that seals the case 50 as shown in FIG. 1. Additionally, in FIG. 2, the rechargeable lithium battery 100 may include a positive electrode lead tab 11, a positive electrode terminal 12 connected to the positive electrode lead tab 11, a negative electrode lead tab 21, and a negative electrode terminal 22 connected to the negative electrode lead tab 21. As shown in FIG. 3 and FIG. 4, the rechargeable lithium battery 100 includes an electrode tab 70 illustrated in FIG. 4, or a positive electrode tab 71 and a negative electrode tab 72 illustrated in FIG. 3, the electrode tabs 70/71/72 forming an electric path for inducing the current formed in the electrode assembly 40 to the outside of the battery 100. According to some example embodiments, a rechargeable lithium battery may include an electrode assembly including the positive electrode and the negative electrode in the form of a jelly-roll.

### Positive Electrode

The positive electrode includes a positive electrode current collector, and a positive electrode active material layer on the positive electrode current collector. The positive electrode active material layer may further include a binder, a conductive material, or a combination thereof in addition to the positive electrode active material.

The positive electrode active material may be or include at least one of a compound capable of reversibly intercalating and deintercalating lithium (lithiated intercalation compound). For example, at least one or more of a composite oxide of lithium and a metal such as or including at least one of cobalt, manganese, nickel, and a combination thereof may be used.

The composite oxide may be or include a lithium transition metal composite oxide, and examples thereof may include at least one of lithium nickel-based oxide, lithium cobalt-based oxide, lithium manganese-based oxide, a lithium iron phosphate-based compound, cobalt-free nickel-manganese-based oxide, lithium-rich layered oxide, or a combination thereof.

For example, the positive electrode active material may be or include a high-nickel positive electrode active material in which a nickel content is greater than or equal to about 80 mol % based on 100 mol % of metals excluding lithium in a lithium transition metal composite oxide. In the high-nickel positive electrode active material, the nickel content may be greater than or equal to about 85 mol %, greater than or equal to about 90 mol %, greater than or equal to about 91 mol %, or greater than or equal to about 94 mol %, and less than or equal to about 99 mol %, based on 100 mol % of the metal excluding lithium. The high-nickel positive electrode active materials may achieve high capacity and may be applied to high-capacity, high-density rechargeable lithium batteries.

As another example, a compound represented by any one of the following chemical formulas may be used. LiₐA_{1-b}X_{b}O_{2-c}D_{c} (0.90≤a≤1.8, 0≤b≤0.5, 0≤c≤0.05); LiₐMn_{2-b}X_{b}O_{4-c}D_{c} (0.90≤a≤1.8, 0≤b≤0.5, 0≤c≤0.05); LiₐNi_{1-b-c}Co_{b}X_{c}O_{2-α}D_{α} (0.90≤a≤1.8, 0≤b≤0.5, 0≤c≤0.5, 0<α<2); Liₐ Ni_{1-b-c}Mn_{b}X_{c}O_{2-α}D_{α} (0.90≤a≤1.8, 0≤b≤0.5, 0≤c≤0.5, 0<α<2); LiₐNi_{b}Co_{c}L¹_{d}GₑO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); Li_{(3-f)}Fe₂(PO₄)₃ (0≤f≤2); LiₐFePO₄ (0.90≤a≤1.8)

In the above chemical formulas, A is or includes at least one of Ni, Co, Mn, or a combination thereof; X is or includes at least one of Al, Ni, Co, Mn, Cr, Fe, Mg, Sr, V, a rare earth element, or a combination thereof; D is or includes at least one of O, F, S, P, or a combination thereof; G is or includes at least one of Al, Cr, Mn, Fe, Mg, La, Ce, Sr, V, or a combination thereof; Q is or includes at least one of Ti, Mo, Mn, or a combination thereof; Z is or includes at least one of Cr, V, Fe, Sc, Y, or a combination thereof; and L¹ is or includes at least one of Mn, Al, or a combination thereof.

The binder improves binding properties of positive electrode active material particles with one another and with a current collector. Examples of the binder may include at least one of polyvinyl alcohol, carboxymethyl cellulose, hydroxypropyl cellulose, diacetyl cellulose, polyvinyl chloride, carboxylated polyvinyl chloride, polyvinyl fluoride, an ethylene oxide-containing polymer, polyvinylpyrrolidone, polyurethane, polytetrafluoroethylene, polyvinylidene fluoride, polyethylene, polypropylene, a styrene-butadiene rubber, a (meth)acrylated styrene-butadiene rubber, an epoxy resin, a (meth)acrylic resin, a polyester resin, or nylon, but are not limited thereto.

The conductive material is included to provide electrode conductivity, and any electrically conductive material may be used as a conductive material unless the electrically conductive material causes an adverse chemical change in the battery. Examples of the conductive material may include a carbon-based material such as at least one of natural graphite, artificial graphite, carbon black, acetylene black, Ketjen black, a carbon fiber, a carbon nanofiber, a carbon nanotube, and the like; a metal-based material of a metal powder or a metal fiber including at least one of copper, nickel, aluminum, silver, and the like; a conductive polymer such as a polyphenylene derivative; or a mixture thereof.

The amount of each of the binder and the conductive material may independently be in a range of about 0.5 wt % to about 5 wt %, based on 100 wt % of the positive electrode active material layer.

The positive electrode current collector may include Al, but the positive electrode current collector is not limited thereto.

### Negative Electrode

The negative electrode may include a current collector and a negative electrode active material layer on the current collector. The negative electrode active material layer may include a negative electrode active material, and may further include a binder, a conductive material, or a combination thereof.

The negative electrode active material may include at least one of a material that reversibly intercalates/deintercalates lithium ions, a lithium metal, a lithium metal alloy, a material capable of doping/dedoping lithium, or transition metal oxide.

The material that reversibly intercalates/deintercalates lithium ions may include, for example crystalline carbon, amorphous carbon, or a combination thereof as a carbon-based negative electrode active material. The crystalline carbon may be irregular, or sheet, flake, spherical, or fiber shaped natural graphite or artificial graphite. The amorphous carbon may be or include at least one of a soft carbon, a hard carbon, a mesophase pitch carbonization product, calcined coke, and the like,

The lithium metal alloy includes an alloy of lithium and a metal such as or including at least one of Na, K, Rb, Cs, Fr, Be, Mg, Ca, Sr, Si, Sb, Pb, In, Zn, Ba, Ra, Ge, Al, and Sn.

The material capable of doping/dedoping lithium may be or include a Si-based negative electrode active material or a Sn-based negative electrode active material. The Si-based negative electrode active material may include at least one of silicon, a silicon-carbon composite, SiOₓ (0<x≤2), a Si-Q alloy (wherein Q is or includes at least one of an alkali metal, an alkaline-earth metal, a Group 13 element, a Group 14 element (excluding Si), a Group 15 element, a Group 16 element, a transition metal, a rare earth element, and a combination thereof, for example at least one of Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Tl, Ge, P, As, Sb, Bi, S, Se, Te, Po, and a combination thereof), or a combination thereof. The Sn-based negative electrode active material may be or include at least one of Sn, SnO₂, a Sn alloy, or a combination thereof.

The silicon-carbon composite may be or include a composite of silicon and amorphous carbon. An average particle diameter (D₅₀) of the silicon-carbon composite particles may be, for example, in a range of about 0.5 μm to about 20 μm. According to some example embodiments, the silicon-carbon composite may be in the form of silicon particles and amorphous carbon coated on the surface of the silicon particles. For example, the silicon-carbon composite may include a secondary particle (core) in which silicon primary particles are assembled, and an amorphous carbon coating layer (shell) on the surface of the secondary particle. The amorphous carbon may also be present between the silicon primary particles, for example, the silicon primary particles may be coated with amorphous carbon. The secondary particles may be dispersed in an amorphous carbon matrix.

The silicon-carbon composite may further include crystalline carbon. For example, the silicon-carbon composite may include a core including crystalline carbon and silicon particles, and an amorphous carbon coating layer on the surface of the core. The crystalline carbon may be or include artificial graphite, natural graphite, or a combination thereof. The amorphous carbon may include at least one of soft carbon or hard carbon, a mesophase pitch carbonized product, and calcined coke.

If (when) the silicon-carbon composite includes silicon and amorphous carbon, an amount of silicon may be in a range of about 10 wt % to about 50 wt %, and an amount of amorphous carbon may be in a range of about 50 wt % to about 90 wt %, based on 100 wt % of the silicon-carbon composite. In addition, if (when) the composite includes silicon, amorphous carbon, and crystalline carbon, an amount of silicon may be in a range of about 10 wt % to about 50 wt %, an amount of crystalline carbon may be in a range of about 10 wt % to about 70 wt %, and an amount of amorphous carbon may be in a range of about 20 wt % to about 40 wt % based on 100 wt % of the silicon-carbon composite.

Additionally, a thickness of the amorphous carbon coating layer may be in a range of about 5 nm to about 100 nm. An average particle diameter (D₅₀) of the silicon particles (primary particles) may be in a range of about 10 nm to about 1 μm, or about nm to about 200 nm. The silicon particles may be present as silicon alone, in the form of a silicon alloy, or in an oxidized form. The oxidized form of silicon may be represented by SiOₓ (0<x≤2). At this time, the atomic content ratio of Si:O, which indicates a degree of oxidation, may be in a range of about 99:1 to about 33:67. As used herein, when a definition is not otherwise provided, an average particle diameter (D₅₀) indicates a particle where a cumulative volume is about 50 volume % in a particle size distribution.

The Si-based negative electrode active material or Sn-based negative electrode active material may be mixed with the carbon-based negative electrode active material. When the Si-based negative electrode active material or Sn-based negative electrode active material and the carbon-based negative electrode active material are mixed together, the mixing ratio may be a weight ratio in a range of about 1:99 to about 90:10.

The binder adheres the negative electrode active material particles to each other, and adheres the negative electrode active material to the current collector. The binder may be or include a non-aqueous binder, an aqueous binder, a dry binder, or a combination thereof.

The non-aqueous binder may include at least one of polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, polyamideimide, polyimide, or a combination thereof.

The aqueous binder may include at least one of a styrene-butadiene rubber, a (meth)acrylated styrene-butadiene rubber, a (meth)acrylonitrile-butadiene rubber, a (meth)acrylic rubber, a butyl rubber, a fluorine rubber, polyethylene oxide, polyvinylpyrrolidone, polyepichlorohydrin, polyphosphazene, poly(meth)acrylonitrile, an ethylene propylene diene copolymer, polyvinylpyridine, chlorosulfonated polyethylene, latex, a polyester resin, a (meth)acrylic resin, a phenol resin, an epoxy resin, polyvinyl alcohol, or a combination thereof.

When an aqueous binder is used as the negative electrode binder, a cellulose-based compound capable of imparting viscosity may be further included. As the cellulose-based compound, one or more of carboxymethyl cellulose, hydroxypropylmethyl cellulose, methyl cellulose, or alkali metal salts thereof may be mixed together. The alkali metal may be or include at least one of Na, K, or Li.

The dry binder may be or include a polymer material capable of becoming a fiber, and may be or include, for example, at least one of polytetrafluoroethylene, polyvinylidene fluoride, a polyvinylidene fluoride-hexafluoropropylene copolymer, polyethylene oxide, or a combination thereof.

The conductive material is included to provide electrode conductivity, and any electrically conductive material may be used as a conductive material unless the electrically conductive material causes an adverse chemical change in the battery. Examples of the conductive material include a carbon-based material such as at least one of natural graphite, artificial graphite, carbon black, acetylene black, Ketjen black, a carbon fiber, a carbon nanofiber, a carbon nanotube, and the like; a metal-based material of a metal powder or a metal fiber including at least one of copper, nickel, aluminum silver, and the like; a conductive polymer such as a polyphenylene derivative; or a mixture thereof.

An amount of the negative electrode active material may be in a range of about 95 wt % to about 99.5 wt % based on 100 wt % of the negative electrode active material layer, and an amount of the binder may be in a range of about 0.5 wt % to about 5 wt % based on 100 wt % of the negative electrode active material layer. For example, the negative electrode active material layer may include a range of about 90 wt % to about 99 wt % of the negative electrode active material, a range of about 0.5 wt % to about 5 wt % of the binder, and a range of about 0.5 wt % to about 5 wt % of the conductive material.

The negative electrode current collector may include, for example, at least one of indium (In), copper (Cu), magnesium (Mg), stainless steel, titanium (Ti), iron (Fe), cobalt (Co), nickel (Ni), zinc (Zn), aluminum (Al), germanium (Ge), lithium (Li), or an alloy thereof, and may be in the form of a foil, sheet, or foam. A thickness of the negative electrode current collector may be, for example, in a range of about 1 μm to about 20 μm, about 5 μm to about 15 μm, or about 7 μm to about 10 μm.

### Electrolyte

For example, the electrolyte for a rechargeable lithium battery may be or include an electrolyte solution, which may include a non-aqueous organic solvent and a lithium salt.

The non-aqueous organic solvent constitutes a medium for transmitting ions taking part in the electrochemical reaction of a battery. The non-aqueous organic solvent may be or include at least one of a carbonate-based, ester-based, ether-based, ketone-based, or alcohol-based solvent, an aprotic solvent, or a combination thereof.

The carbonate-based solvent may include at least one of dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and the like. The ester-based solvent may include at least one of methyl acetate, ethyl acetate, n-propyl acetate, dimethyl acetate, methyl propionate, ethyl propionate, decanolide, mevalonolactone, valerolactone, caprolactone, and the like. The ether-based solvent may include at least one of dibutyl ether, tetraglyme, diglyme, dimethoxyethane, 2-methyltetrahydrofuran, 2,5-dimethyltetrahydrofuran, tetrahydrofuran, and the like. In addition, the ketone-based solvent may include cyclohexanone, and the like. The alcohol-based solvent may include ethanol, isopropyl alcohol, and the like. The aprotic solvent may include at least one of nitriles such as R-CN (wherein R is a C2 to C20 linear, branched, or cyclic hydrocarbon group, a double bond, an aromatic ring, or an ether bond, and the like); amides such as dimethylformamide; dioxolanes such as 1,3-dioxolane, 1,4-dioxolane, and the like; sulfolanes, and the like.

The non-aqueous organic solvent may be used alone, or in a mixture of two or more solvents, and when two or more types are used in a mixture, a mixing ratio can be adjusted as desired according to the desired battery performance, which is known to those working in the field.

When using a carbonate-based solvent, a cyclic carbonate and a chain carbonate may be mixed together, and the cyclic carbonate and the chain carbonate may be mixed in a volume ratio in a range of about 1:1 to about 1:9.

The non-aqueous organic solvent may further include an aromatic hydrocarbon-based organic solvent. For example, a carbonate-based solvent and an aromatic hydrocarbon-based organic solvent may be mixed together in a volume ratio in a range of about 1:1 to about 30:1.

The electrolyte solution may further include at least one of vinylethyl carbonate, vinylene carbonate, or an ethylene carbonate-based compound to improve battery cycle-life.

Examples of the ethylene carbonate-based compound may include at least one of fluoroethylene carbonate, difluoroethylene carbonate, chloroethylene carbonate, dichloroethylene carbonate, bromoethylene carbonate, dibromoethylene carbonate, nitroethylene carbonate, cyanoethylene carbonate, and the like.

The lithium salt dissolved in the organic solvent supplies lithium ions in a battery, enables an operation of a rechargeable lithium battery, and improves transportation of the lithium ions between positive and negative electrodes. Examples of the lithium salt may include at least one of LiPF₆, LiBF₄, LiSbF₆, LiAsF₆, LiClO₄, LiAlO₂, LiAlCl₄, LiPO₂F₂, LiCl, LiI, LiN(SO₃C₂F₅)₂, Li(FSO₂)₂N (lithium bis(fluorosulfonyl)imide; LiFSI), LiC₄F₉SO₃, LiN(CₓF₂ₓ₊₁SO₂)(C_{y}F_{2y+1}SO₂) (wherein x and y are integers in a range of 1 to 20), lithium trifluoromethane sulfonate, lithium tetrafluoroethanesulfonate, lithium difluorobis(oxalato)phosphate (LiDFBOP), and lithium bis(oxalato) borate (LiBOB).

A concentration of lithium salt may be within the range of about 0.1 M to about 2.0 M. If (when) the concentration of lithium salt is within the above range, the electrolyte solution has desired ionic conductivity and viscosity, and thus desired or improved performance can be achieved, and lithium ions can move effectively.

### Separator

Depending on the type of the rechargeable lithium battery, a separator may be present between the positive electrode and the negative electrode. The separator may include at least one of polyethylene, polypropylene, polyvinylidene fluoride, or a multilayer film of two or more layers thereof, and a mixed multilayer film such as a polyethylene/polypropylene two-layer separator, polyethylene/polypropylene/polyethylene three-layer separator, polypropylene/polyethylene/polypropylene three-layer separator, and the like.

The separator may include a porous substrate and a coating layer including an organic material, an inorganic material, or a combination thereof, on one surface, or on both surfaces, of the porous substrate.

The porous substrate may be or include a polymer film formed of or including at least any one or more of polyolefin such as polyethylene and polypropylene, polyester such as polyethylene terephthalate and polybutylene terephthalate, polyacetal, polyamide, polyimide, polycarbonate, polyether ketone, polyarylether ketone, polyether ketone, polyetherimide, polyamideimide, polybenzimidazole, polyethersulfone, polyphenylene oxide, a cyclic olefin copolymer, polyphenylene sulfide, polyethylene naphthalate, a glass fiber, TEFLON, and polytetrafluoroethylene, or a copolymer or mixture of two or more thereof.

The porous substrate may have a thickness in a range of about 1 μm to about 40 μm, for example, about 1 μm to about 30 μm, about 1 μm to about 20 μm, about 5 μm to about 15 μm, or about 10 μm to about 15 μm.

The organic material may include a (meth)acrylic copolymer including a first structural unit derived from (meth)acrylamide, and a second structural unit including at least one of a structural unit derived from (meth)acrylic acid or (meth)acrylate, and a structural unit derived from (meth)acrylamidosulfonic acid or a salt thereof.

The inorganic material may include inorganic particles such as or including at least one of Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and a combination thereof, but is not limited thereto. An average particle diameter (D₅₀) of the inorganic particles may be in a range of about 1 nm to about 2000 nm, for example, about 100 nm to about 1000 nm, or about 100 nm to about 700 nm.

The organic material and the inorganic material may be mixed in one coating layer, or a coating layer including an organic material and a coating layer including an inorganic material may be stacked together.

The thickness of the coating layer may be in a range of about 0.5 μm to about 20 μm, for example, about 1 μm to about 10 μm, or about 1 μm to about 5 μm.

Examples and comparative examples of the present disclosure are described below. However, the following examples are only examples of the present disclosure, and the present disclosure is not limited to the following examples.

### Example 1

### (1) Manufacturing of Positive Electrode

A polymer composition was prepared by adding poly urethane (manufacturer: Sigma-Aldrich, model name: 81637) and poly caprolactone (manufacturer: Sigma-Aldrich, model name: 440752, weight average molecular weight: 14,000 g/mol) in a weight ratio of 70:30 in an NMP solvent and then, adding a SWCNT conductive material thereto. Herein, the polymer composition was adjusted to have a solid content of 50 wt % and include 95 wt % of the polymer and 5 wt % of the conductive material based on 100 wt % of a total of the polymer and the conductive material.

After coating the polymer composition on a 6 μm-thick aluminum foil (first metal layer), another 6 μm-thick aluminum foil (second metal layer) was attached onto the surface of the first metal layer where the polymer composition was coated, and then dried at 80° C. under a vacuum atmosphere, manufacturing a triple-layered positive electrode current collector in which a 5 μm-thick polymer layer was formed between two aluminum foils.

After preparing a slurry for a positive electrode active material layer by mixing 98.15 wt % of a positive electrode active material (LiCoO₂), 0.8 wt % of carbon black, and 1.05 wt % of a PVDF binder in an NMP solvent, the slurry for a positive electrode active material layer was coated on the positive electrode current collector, and then dried and compressed to form a positive electrode active material layer on the positive electrode current collector, thereby manufacturing a positive electrode.

### (2) Manufacturing of Negative Electrode

97.5 wt % of a graphite negative electrode active material, 1 wt % of carboxymethyl cellulose, and 1.5 wt % of styrene butadiene rubber were mixed in a water solvent to prepare a slurry for forming a negative electrode active material layer. The slurry for forming a negative electrode active material layer was coated on a copper foil, a negative electrode current collector, and then dried and compressed to form a negative electrode active material layer on the negative electrode current collector, thereby manufacturing a negative electrode.

### (3) Manufacturing of Rechargeable Lithium Battery Cell

The positive and negative electrodes were used with a polytetrafluoroethylene separator and an electrolyte solution prepared by mixing ethylene carbonate and dimethyl carbonate in a volume ratio of 3:7 and dissolving 1 M LiPF₆ in the mixed solvent to manufacture a rechargeable lithium battery cell in a common method.

### Example 2

A rechargeable lithium battery cell was manufactured substantially in the same manner as in Example 1, except that poly carbonate and poly lactide instead of the poly urethane and the poly caprolactone were mixed in a weight ratio of 80:20 in manufacturing the positive electrode.

### Example 3

A rechargeable lithium battery cell was manufactured substantially in the same manner as in Example 1, except that polyethylene instead of the poly urethane was used in manufacturing the positive electrode.

### Example 4

A rechargeable lithium battery cell was manufactured substantially in the same manner as in Example 1, except that poly dimethylsiloxane and polyglycolic acid instead of the poly urethane and the poly caprolactone were mixed in a weight ratio of 90:10 in manufacturing the positive electrode.

### Comparative Example 1

A rechargeable lithium battery cell was manufactured substantially in the same manner as in Example 1, except that a monolayered aluminum was used instead of the triple-layered positive electrode current collector in manufacturing the positive electrode.

### Comparative Example 2

A rechargeable lithium battery cell was manufactured substantially in the same manner as in Example 1, except that the poly urethane alone was used without using the poly caprolactone as the polymer.

### Comparative Example 3

A rechargeable lithium battery cell was manufactured substantially in the same manner as in Example 1, except that the poly caprolactone alone was used without using the poly urethane as the polymer.

### Evaluation Example 1: Evaluation of Shape Resilience of Battery Cells

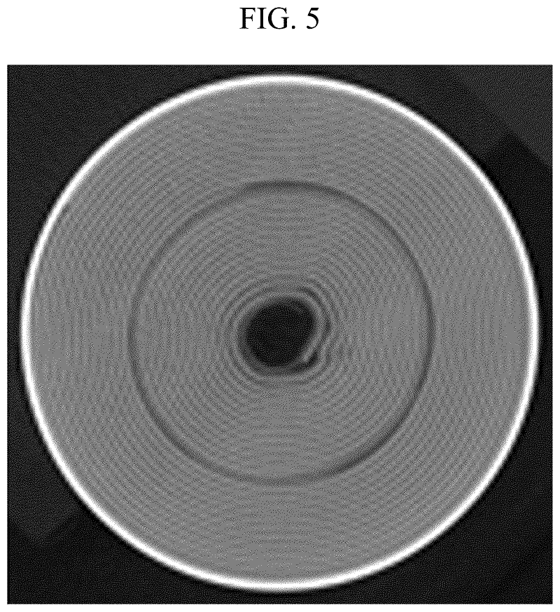

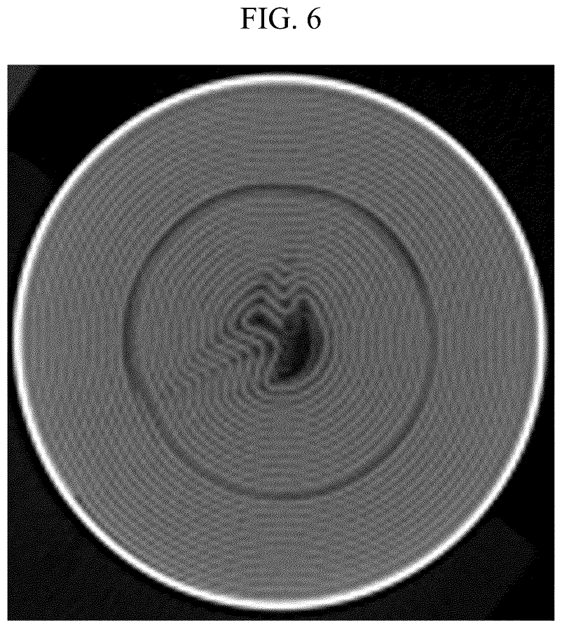

Cylindrical battery cells were manufactured in the same manner as the cells of Example 1 and Comparative Example 1, and then charged to an upper limit voltage of 4.25 V at a constant current of 0.1 C and to 0.05 C at the constant voltage and discharged to a cut-off voltage of 2.8 V at 0.1 C at 25° C. for initial formation and then, 50 times repeatedly charged and discharged within a voltage range of 3.0 V to 4.25 V at 1.0 C at 60° C. Subsequently, the same cylindrical battery cells manufactured in the same manner as the cells of Example 1 and Comparative Example 1 were taken cross-sectional images of the jelly-rolls through CT (Computed Tomography), and the image results are respectively shown in FIG. 5 and FIG. 6.

Referring to FIG. 5, Example 1 shows that the shape memory polymer included in the polymer layer effectively reduces or suppresses deformation of the battery cell during the cycle process in the high-temperature environment, and even if (when) the cycles were repeated, to maintain the battery structure.

On the other hand, referring to FIG. 6, Comparative Example 1, which included no polymer layer including the shape memory polymer, shows that the battery cell was deformed in the winding core direction thereof, not maintaining the battery structure. Accordingly, the battery cell of Example 1 exhibited desired or improved shape resilience, compared to Comparative Example 1.

### Evaluation Example 2: Evaluation of Shape Resilience of Polymer Layer

The polymer compositions of Examples 1 to 4 and Comparative Examples 2 and 3 were respectively injected into a mold, cooled/solidified, extruded to have a uniform thickness, and pressed to prepare specimens for experiments.

Subsequently, each of the specimens was placed in a temperature control device, and then heated to 80° C., compressed at a constant pressure of 1 MPa, and then, cooled at 0° C. for 10 minutes to fix the deformation state thereof. Each of the specimens with the deformation state fixed was taken from the device and then, reheated at 80° C. to evaluate whether or not the specimen recovered to the original shape thereof.

The specimens were measured with respect to an initial length before applying an external force thereto, a length in a deformed and fixed state, and a length after the recovery to calculate a shape recovery rate R according to Equation 1 below.

$$R = ( {L}_{r} - {L}_{d} ) / ( {L}_{0} - {L}_{d} ) \times 100 . \qquad Equation 1$$

In Equation 1, L₀ represents the initial length before applying an external force, L_{d} represents the length in a deformed and fixed state, and Lr represents the length after recovery.

The polymer layers were evaluated with respect to presence or absence of shape resilience, wherein referring to the above R, 95% of R or higher was determined as the presence of shape resilience (marked by ‘o’ in Table 1) and less than 30% of R was determined as the absence of shape resilience (marked by ‘X’ in Table 1), and the results are shown in Table 1 below.

TABLE 1

| | Presence or absence of shape resilience |
|---|---|
| Example 1 | ◯ |
| Example 2 | ◯ |
| Example 3 | ◯ |
| Example 4 | ◯ |
| Comparative Example 2 | X |
| Comparative Example 3 | X |

Referring to Table 1 above, the polymer layers formed of the polymer compositions of Example 1 to 4 were confirmed to have shape resilience in the high-temperature environment.

On the other hand, the polymer layers formed of the polymer compositions of Comparative Examples 2 and 3 had substantially no shape resilience in the high-temperature environment, because both the first polymer and the second polymer were not used.

### Evaluation Example 3: Evaluation of Charge/Discharge Performance

The rechargeable lithium battery cells of Example 1 and Comparative Example 1 were charged to an upper limit voltage of 4.25 V at a constant current of 0.1 C and to 0.05 C at the constant voltage, and then discharged to a cut-off voltage of 2.8 V at 0.1 C at 25° C. for initial formation and measured with respect to initial charge capacity, initial discharge capacity, and a ratio of the latter to the former as initial efficiency, and the results are shown in Table 2 below.

TABLE 2

| | Initial charge | Initial discharge | Efficiency |
|---|---|---|---|
| | capacity (mAh) | capacity (mAh) | (%) |
| Example 1 | 4879 | 4823 | 98.8% |
| Comparative | 4798 | 4660 | 97.1 |
| Example 1 | | | |

Referring to Table 2 above, Example 1 exhibited desired or improved initial charge and discharge capacity and initial efficiency, compared to Comparative Example 1.

### Evaluation Example 4: Evaluation of Cycle-life Performance

The rechargeable lithium battery cells of Example 1 and Comparative Example 1 were 20 cycles repeatedly charged and discharged within a voltage range of 3.0 V to 4.25 V at 1.0 C at 60° C. after the initial charge and discharge of Evaluation Example 3 to calculate a ratio of 20^{th} cycle discharge capacity to the initial discharge capacity, and the results are shown in Table 3 below.

TABLE 3

| | 20^{th} capacity retention rate (%) |
|---|---|
| Example 1 | 98% |
| Comparative Example 1 | 96% |

Referring to Table 3 above, Example 1 exhibited a higher 20^{th} capacity retention rate than Comparative Example 1, which confirmed desired or improved cycle-life performance of Example 1.

While this disclosure has been described in connection with what is presently considered to be practical example embodiments, it is to be understood that the disclosure is not limited to the disclosed embodiments. On the contrary, the disclosure is intended to cover various modifications and equivalent arrangements included within the spirit and scope of the appended claims.

### DESCRIPTION OF SYMBOLS

100: rechargeable lithium battery 10: positive electrode
11: positive electrode lead tab 12: positive electrode terminal
20: negative electrode 21: negative electrode lead tab
22: negative electrode terminal 30: separator
40: electrode assembly 50: case
60: sealing member 70: electrode tab
71: positive electrode tab 72: negative electrode tab

What is claimed is:

1. An electrode current collector, comprising:
a first metal layer;
a second metal layer; and
a polymer layer between the first metal layer and the second metal layer;
wherein the polymer layer includes a first polymer and a second polymer,
the first polymer comprises at least one of polyurethane, polyethylene, polycarbonate, polydimethylsiloxane, and a combination thereof, and
the second polymer comprises at least one of polycaprolactone, polylactide, polyglycolic acid, and a combination thereof.

2. The electrode current collector as claimed in claim 1, wherein the polymer layer comprises a range of about 50 wt % to about 90 wt % of the first polymer based on the total 100 wt % of the first polymer and the second polymer.

3. The electrode current collector as claimed in claim 1, wherein the polymer layer comprises a range of about 10 wt % to about 50 wt % of the second polymer based on the total 100 wt % of the first polymer and the second polymer.

4. The electrode current collector as claimed in claim 1, wherein a thickness of the polymer layer is in a range of about 1 μm to about 10 μm.

5. The electrode current collector as claimed in claim 1, wherein the polymer layer further comprises a conductive material.

6. The electrode current collector as claimed in claim 5, wherein the conductive material is included in an amount greater than about 0 wt % and less than or equal to about 10 wt % based on 100 wt % of the polymer layer.

7. The electrode current collector as claimed in claim 1, wherein a sum of the first polymer and the second polymer is included in an amount greater than or equal to about 90 wt % and less than about 100 wt % based on 100 wt % of the polymer layer.

8. The electrode current collector as claimed in claim 1, wherein the first metal layer and the second metal layer each independently comprises at least one of indium (In), copper (Cu), magnesium (Mg), stainless steel (SUS), titanium (Ti), iron (Fe), cobalt (Co), nickel (Ni), zinc (Zn), aluminum (Al), germanium (Ge), lithium (Li), and a combination thereof.

9. The electrode current collector as claimed in claim 1, wherein a thickness of the first metal layer is in a range of about 1 μm to about 20 μm.

10. The electrode current collector as claimed in claim 1, wherein a thickness of the second metal layer is in a range of about 1 μm to about 20 μm.

11. The electrode current collector as claimed in claim 1, wherein a thickness ratio of the first metal layer to the second metal layer is in a range of about 3:7 to about 7:3.

12. The electrode current collector as claimed in claim 1, wherein a total thickness of the first metal layer and the second metal layer is in a range of about 50 thickness % to about 95 thickness % based on a total 100 thickness % of the electrode current collector.

13. The electrode current collector as claimed in claim 1, wherein a thickness of the polymer layer is in a range of about 5 thickness % to about 50 thickness % based on a total 100 thickness % of the electrode current collector.

14. The electrode current collector as claimed in claim 1, wherein a thickness of the polymer layer is in a range of about 3 thickness % to about 50 thickness % based on a sum of the thickness of the first metal layer and the thickness of the second metal layer.

15. An electrode comprising the electrode current collector as claimed in claim 1.

16. The electrode as claimed in claim 15, wherein the electrode comprises at least one of a positive electrode and a negative electrode.

17. The electrode as claimed in claim 15, wherein:
the electrode is a positive electrode, and
the first metal layer and the second metal layer include aluminum.

18. The electrode as claimed in claim 15, wherein:
the electrode is a negative electrode, and
the first metal layer and the second metal layer include copper.

19. A rechargeable lithium battery, comprising:
a positive electrode;
a negative electrode; and
an electrolyte;
wherein at least one of the positive electrode and the negative electrode is the electrode as claimed in claim 15.
